(19) United States
(12) Patent Application Publication
(10) Pub. No.: US 2026/0117559 A1
(43) Pub. Date: Apr. 30, 2026

(54) FINDING AND COMMUNICATING LOST KEY AFTER AN EVENT USING A WIRELESS COMMUNICATIONS DEVICE

(71) Applicant: Honeywell International Inc., Charlotte, NC (US)

(72) Inventor: Teri Briskey, Monmouth, OR (US)

(21) Appl. No.: 18/931,008

(22) Filed: Oct. 29, 2024

(51) Int. Cl. E05B 19/00; G06Q 50/163

(52) U.S. Cl. CPC E05B 19/0005; G06Q 50/163

(57) ABSTRACT

A system and method for tracking and managing keys used in real estate property showings is disclosed. The system comprises an electronic lockbox assigned to a property address, a key attached to an asset tag, and a software downloaded onto a wireless access device. When the key is removed from the lockbox, the system monitors its location relative to the lockbox and geofence. If the key crosses the geofence and is still in communication with the wireless access device, the system sends a series of real-time notifications to the relevant parties, including the showing agent and subsequent schedule agents/authorized users. The system also detects when the key is returned to the lockbox, updating all parties and removing any warnings. Examples provide efficiency and security in real estate key management by leveraging wireless communication technology, geofence, and targeted notifications to prevent key misplacement and minimize disruptions to property showings.

### BACKGROUND

This application relates to systems and methods for locating a key missing from a lockbox after an event. A lockbox refers to a lock equipped with locked compartment for holding or receiving a key, including but not limited to conventional physical keys or Key Frequency Operated Button (FOBs). The lockbox is typically kept on the property having the lock into which the key is inserted.

For example, a real estate showing agent (“showing agent”) takes a client to a premises listed for sale. Access to the premises is given by removing a key which is stored in an electronic lockbox. After the showing, however, the showing agent may forget to return the house key to the lockbox, and instead leaves the premises with the key on their person or their bag, unbeknownst to other agents with subsequent showings, who will be unable to access the property without the key. In turn, this creates a loss of time for the agent, later-arriving showing agents, and potential buyers, or even may cause the loss of a sale.

Current iteration lockboxes function by assigning the lockbox to a listing address, wherein the assignment process creates a digital geofence around the listing address. A showing agent then can use a mobile application on their wireless access device (e.g., a smartphone) to unlock the lockbox and access the key to the listing. When the showing agent leaves the premises and crosses the geofence, the application on their device sends a signal to a central authority that the showing has ended. This signal occurs whether or not the key has been returned to the lockbox. In those instances, no information regarding when the key crossed the geofence, nor which of possibly many showing agents has possession of the key is generated.

### Overview

Illustrative examples track a key in the event the key has been carried away from an intended location or property. The tracking information may also determine which user has possession of the key as well as the time when the key was removed from the property. Tracking and other information may be generated, in illustrative examples, by the interaction of a user's mobile device with the asset tag physically attached to the key that is to be contained in the lockbox.

A first illustrative and non-limiting example takes the form of a method for tracking a key for a property, the key stored in a lockbox, the method performed by use of a property access management tracking software, the method comprising: assigning a property address to the lockbox and to a wireless asset tag physically attached to the key for the property; establishing an electronic geofence surrounding the property; a) establishing wireless communication between the wireless asset tag and a wireless access device, the wireless access device being possessed by a user visiting the property; b) determining, after step a), that the wireless access device has crossed outside the geofence surrounding the property address; and c) determining, responsive to step b), that communication between the wireless access device and the wireless asset tag has continued after step b); and in response to the determinations b) and c), generating at least one notification indicating that the key is outside the geofence.

Additionally or alternatively, the method also includes transmitting the determinations b) and c) and at least one notification to a central authority for distribution over a wireless network service. Additionally or alternatively, the at least one notification indicates that the user of the wireless access device has possession of the key. Additionally or alternatively, the at least one notification instructs the user of the wireless device to return the key to the lockbox. Additionally or alternatively, the at least one notification is directed to other agents associated with the property.

Additionally or alternatively, the property is a real estate listing having a showing schedule associated therewith, and the at least one notification is sent to an agent on the showing schedule to indicate the key is unavailable. Additionally or alternatively, the method also includes establishing wireless communication between the wireless asset tag and the lockbox at the property. Additionally or alternatively, determination b) is made when communication between the wireless asset tag and the lockbox has terminated due to increasing geographic distance. Additionally or alternatively, the method also includes establishing wireless communication between the wireless access device and the lockbox at the property, and in response thereto, providing access to the key at the lockbox to a possessor of the wireless access device.

Additionally or alternatively, the method also includes recording, at the lockbox, an identifier of the wireless access device used to establish wireless communication with the lockbox to access the key, and using the identifier of the wireless access device to direct at least one notification indicating that the key is outside the geofence.

Additionally or alternatively, the property is a real estate listing, and wherein the at least one notification includes a transmission to a central server and the method further comprises the central server generating a warning on a listing page for the property that the key is currently unavailable. Additionally or alternatively, the geofence encompasses an area around the property address, forming a virtual boundary.

Additionally or alternatively, the property access management software utilizes a wireless data service network, Wi-Fi, a global positioning system, a radio frequency identification, or a mobile phone's location services to define the virtual boundary of the geofence.

Another illustrative and non-limiting example takes the form of a method for tracking a key stored within a lockbox for a property, the method comprising: initializing the property access management software by: assigning a property address to the lockbox; physically attaching a wireless asset tag to the key, and associating the wireless asset tag to the property address; and establishing an electronic geofence surrounding the property linking a mobile device of an authorized user to the lockbox via a wireless communication, wherein the linking establishes authority for the user to access the key stored within the lockbox; the lockbox allowing the user to obtain the key and physically attached wireless access tag therefrom; a) detecting that the wireless access device has crossed outside the geofence; b) detecting that the association between the wireless access device and the wireless asset tag has continued after step a); and in response to a) and b), generating at least one notification indicating that the key is outside the geofence.

Additionally or alternatively, generating at least one notification includes issuing an alert, using the mobile device, to the authorized user that the key has passed beyond the geofence without being returned to the lockbox.

Additionally or alternatively, the method also includes detecting that the wireless asset tag has returned to the lockbox and generating a notification that the key has been returned. Additionally or alternatively, linking the wireless access device to the lockbox further comprises storing user credentials on the wireless access device, and storing identifying information for the mobile device on the lockbox when the wireless access device is linked to the lockbox. Additionally or alternatively, accessing the key from the lockbox using the wireless access device further comprises: authenticating user credentials by the lockbox; and unlocking the lockbox upon successful authentication of user credentials.

Another illustrative and non-limiting example takes the form of a system for tracking a key for a property, the key stored in a lockbox, the system comprising: a lockbox assigned to a property address; a wireless asset tag physically attached to the key for the property; a mobile device possessed by a user visiting the property and having thereon a mobile application; a central server adapted for communication with at least the mobile device which is operating the mobile application, wherein: the central server stores data associating the property address with the lockbox, the wireless asset tag, and an electronic geofence surrounding the property; wherein the mobile application is configured to use the mobile device to communicatively link to the lockbox to allow the user to access the key stored therein; wherein the mobile application is configured to use the mobile device to communicatively link to the wireless asset tag attached to the key and to then: a) determine that the wireless access device has crossed outside the geofence surrounding the property address; b) determine, responsive to a), that communication between the wireless access device and the wireless asset tag has continued after a); and in response to a) and b) generate at least one notification indicating that the key is outside the geofence.

Additionally or alternatively, the mobile application is configured to generate the at least one notification by issuing an alert to the user carrying the mobile device.

Additionally or alternatively, the central server is further configured to communicate with an access control device possessed by a listing agent for the property such that when the listing agent configures the lockbox at the property, the central server stores the association of the property address with the lockbox, and when the listing agent configures the wireless asset tag with the key, the central server stores the association of the property address with the wireless asset tag. Additionally or alternatively, the access control device possessed by the listing agent is a mobile device. Additionally or alternatively, the access control device possessed by the listing agent or the central server defines the geofence.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE DRAWINGS

The drawings illustrate, by way of example, but not by way of limitation, various embodiments discussed herein. In the drawings, which are not necessarily drawn to scale, like numerals may describe similar components in different views.

FIG. 1 illustrates a geofence when the lockbox is assigned to a property.

FIG. 2 represents the assignment between a key and the asset tag.

FIG. 3A illustrates a first and second exemplary notification event in a series of notifications occurring when the key is taken off premises.

FIG. 3B illustrates a third exemplary notification event in a series of notifications occurring when the key is taken off premises.

FIG. 4A is a screen mockup of an exemplary notification event shown to the showing agent in a series of notifications occurring when the key is taken off premises.

FIG. 4B is a screen mockup of an exemplary notification shown to others associated with the property in a series of notifications occurring when the key is taken off premises.

FIG. 5 is a screen mockup of the warning on the listing page in the property access management tracking system that the key is currently unavailable to access the property.

FIG. 6A is a screen mockup of an exemplary notification shown to the showing agent when the key has been returned to the lockbox.

FIG. 6B is a screen mockup of an exemplary notification shown to the listing agents and other users associated with the property when the key has been returned to the lockbox.

FIG. 7 is a block diagram for an illustrative method.

### DETAILED DESCRIPTION

In illustrative examples, a system and method for tracking a key is outlined, comprising a lockbox assigned to a property address, a house key (physical key or key FOB) with an attached asset tag, a mobile application on a user's device, and a central authority (i.e., a server) configured to associate the asset tag with the property address. The asset tag may be, for example and without limitation, a Bluetooth Low Energy (BLE) beacon, tracker or tag; while BLE is referenced herein, any product that can be used to communicate with a mobile device may be used, including those using other wireless solutions or spectrum. The system sends notifications when the asset tag (and thus the key) is detected outside a predefined geofence. This integrated system and method provide real-time tracking and notification capabilities to improve key management, for example, in real estate operations.

In illustrative examples, an asset tag is attached to the house key (physical key or key FOB). The asset tag has a unique identification number which then is associated with the listing's address by the central authority. The lockbox is also uniquely identified assigned to the listing's address. Additionally, the mobile device of an authorized user is uniquely identified and associated with the listing's address by the central authority. The authorized user, such as a showing agent, uses the mobile device operating a mobile application to open the lockbox, such as by near field communication or far field wireless communication, to access and remove the key. The mobile device (such as a smartphone) with the mobile application will communicate with the key at this point and through the remaining process. If the key is not returned to the lockbox and is instead carried across the geofence, the mobile device operating the mobile application will identify the geofence crossing. The mobile application may, in examples, determine that the communication between the mobile application and the lockbox has terminated because the mobile device has traveled too far from the lockbox. In other examples, geo-location (such as a GPS system/chip, or using cellular tower services or other suitable systems) may be used by the mobile device to determine crossing the geofence if, for example, the property is large and a geofence is set beyond the communication range of the lockbox. To identify that the key was not returned, the app software may further determine that the communication between the mobile application and asset tag has not terminated due to their spatial proximity, after crossing the geofence. If those determinations are made, then the mobile application launches a series of communications to interested parties as described in more detail below.

The illustrative system and method are not limited to real estate. For example, the system and method can be used by other authorized users to locate a key or other item in need of security, normally stored within a lockbox on the property, that was carried away from the premises. By leveraging wireless communication technology, geofencing, and real-time notifications, some non-limiting examples significantly improve the efficiency and security of key management in real estate operations. Benefits may include reduced likelihood of lost or misplaced keys, minimized disruptions to property showings, and a powerful tool for managing access to listed properties.

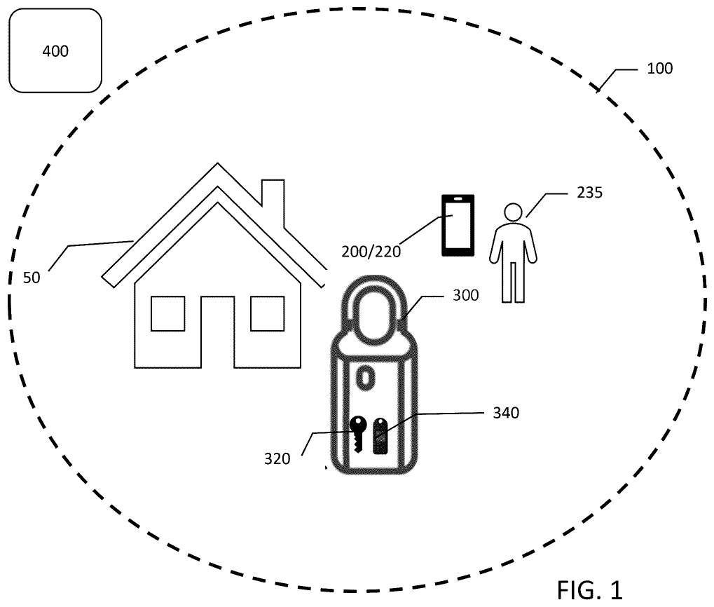

FIG. 1 illustrates the establishment of the geofence 100 when the lockbox 300 is first assigned to the listing address 50—i.e., the address of the property, building, house, or other physical premises to which the lockbox is associated with—by a central authority (i.e., a server 400). Such assignment is typically executed on either a mobile application 220 operating on a mobile device 200 or a web browser in accordance with the directions provided by the lockbox manufacturer. In an example, the lockbox has an identifier, such as a lockbox serial number, which allows the central server to assign or associate the lockbox to the property address. For example, when the lockbox is put into use at the property, the mobile application enters a mode for listing a property in which the lockbox is linked (using standard procedures of the lockbox manufacturer) to the mobile device and mobile application operated thereon. Once linked, the lockbox is opened and the key may be physically placed in the lockbox. When the link takes place, the mobile application obtains identifying information, such as a unique serial number, for the lockbox. The lockbox is also placed at the property, often by secure attachment at the door, on a fence, etc. The mobile device reports to the central server the lockbox identifying information, such as the lockbox serial number, once the lockbox has been placed on the property according to the manufacturer's instructions for the lockbox. The central server uses the obtained information to associate the lockbox with the property address.

The key 320 to the property listing 50 is contained inside the locked compartment of the lockbox 300 at the start of the showing. Additionally, the lockbox 300 contains an electronic actuator configured to unlock the box upon receiving an electronic unlocking signal transmitted by a mobile application 220 or other appropriate software downloaded onto an authorized user's wireless access device 200.

In some embodiments, the lockbox 300 in this system is a BLE (Bluetooth low energy) lockbox. BLE lockboxes offer the advantage of prolonged operation by using far less power than “standard” Bluetooth and are capably suited to transmitting small amounts of data, such is the case here. This energy-efficient characteristic makes BLE lockboxes particularly well-suited for the key tracking system, as they can maintain consistent communication with the wireless access device across a short range suitable for many services, as well as communicating with the asset tag 340 without frequent battery replacements or recharging. Other examples may use any suitable lockbox 300, including lockboxes that open with manually entered codes, lockboxes using combination locks, etc., as the wireless capability of the lockbox is not required in some such examples. It may be sufficient for some examples that the key 320 be associated with an asset tag 340, and the property 50 has a geofence 100 defined thereabout.

The wireless access device 200 may be, for example and without limitation, a cell phone with data capabilities (i.e., a “smartphone” or “phone”). The wireless access device facilitates communication between the user 235, the lockbox 300, and the central servers 400. In this matter, the claimed system and process extend this functionality by enabling the phone 200 to act as a transceiver for the asset tag 340 attached to the key 320. This dual communication capability allows the system to track the key's 320 location relative to both the lockbox 300 and the geofence 100, providing more comprehensive monitoring. In examples, the wireless access device 200 must have at least one data channel for communicating with wireless service networks, including at least one of a cellular carrier network or Wi-Fi. The mobile application 220 or software is typically associated with the manufacturer of the lockbox.

The software does not limit the access to solely one user, for example, multiple listing agents may have authorized access to enable electronic unlocking of the lockbox via the access application 220 or software, each on their wireless communication device.

When the lockbox 300 is assigned to the listing address 50, the mobile application and/or the central server digitally draws a geofence 100 around the listing address. This may be done, for example, by the listing agent using the mobile application in a mode for drawing or creating the geofence. The mobile application 220 or the central server may, for example, use a cellular carrier service network, Wi-Fi, a global positioning system (GPS), or a radio frequency identification (RFID) to define the virtual geographical boundary surrounding the listing. This virtual boundary is referred to the “geofence” 100. The geofence 100 can vary in size, and is generally defined by an authorized user 230 or the preconfigured settings of the software itself. For real estate listings, the geofence 100 may be, for example, confined to the immediate curtilage of the listing. In the case where the wireless access device 200 is a smartphone, the mobile application 220 may utilize the wireless access device's location services to complete the assignment of defining the geofence.

The software may also be programmed with triggers for notification events delivered to either the user that crossed the geofence 120 and/or other authorized access users of the individual lockbox. For example, when a showing agent crosses the geofence 100, a listing agent for the property 50 may receive a notification. In some examples, a showing schedule may be defined, and a subsequent showing agent on the schedule may be notified when the property becomes available when a previous showing agent on the schedule leaves the geofence 100 after having accessed the lockbox 300. Showing agents may also indicate interest in a property using the mobile application, and may receive notifications when the property 50 is available for showing. An occupant of the property 50 may receive a notification when a showing is requested or when a showing is completed. Various scenarios or sequences may be used, without limitation.

Once the listing 50 and lockbox 300 are assigned to each other, the asset tag 340 is both physically secured to the key 320, and is also electronically associated with or assigned to the key. This may be done according to manufacturer's instructions for using the asset tag 340. For example, the mobile application and/or mobile device may link to the asset tag 340 using instructions from manufacturer of the asset tag 340. Unique identifying information, such as a serial number, for the asset tag 340 is obtained at the mobile device and/or mobile application during this linking process. The mobile application communicates the identifying information for the asset tag 340 to the central server, which stores this information as associated with the key for the property and/or property address.

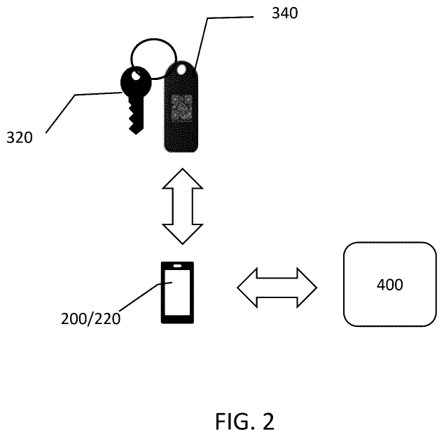

FIG. 2 represents the physical attachment of the listing key 320 and an asset tag 340. In preferred embodiments, the asset tag 340 is a BLE asset tag for the same energy-efficiency advantages as the BLE lockbox and for their small size, which allows for feasible storage of the key and the asset tag within the typically small compartments of lockboxes. Other wireless strategies may be used instead, without limitation. The mobile device 200, operating the mobile application 220, may link with the asset tag 340, for example by Bluetooth pairing methods (or other wireless technology), obtain identifying information for the tag 340, and communicate the identifying information to the server 400. In some examples, the mobile device 200 may scan a QR code on the asset tag 340 as part of this procedure, for added security/confirmation of identity, if desired.

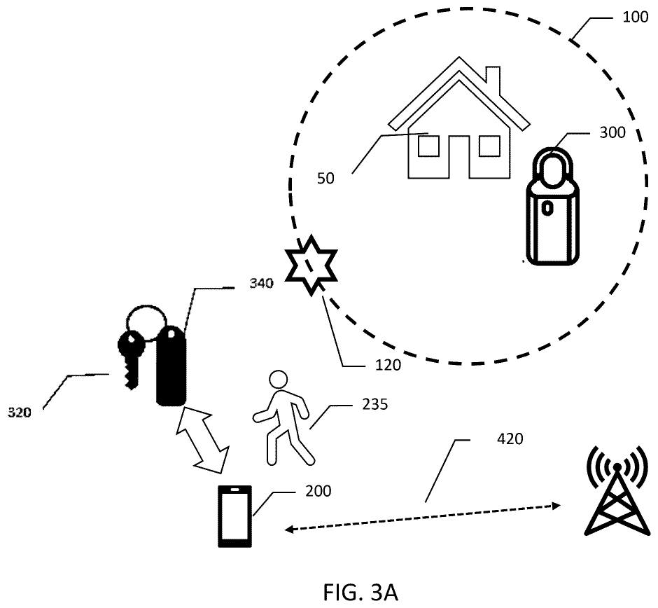

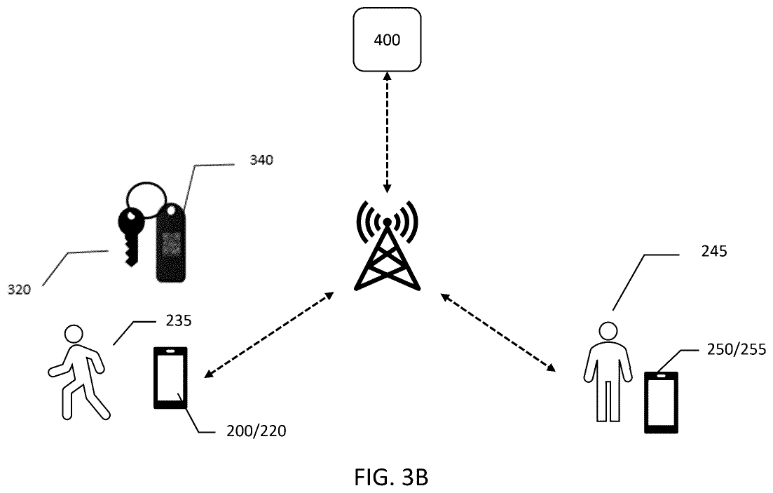

Referring back to FIG. 1, at the end of this initial set up, the geofence 100 is drawn and both the lockbox 300 and the asset tag 340 (attached to the key 320) now assigned to the listing 50 and in communication with the wireless access device 200 via the mobile application 220. The continued communication between the lockbox 300 and asset tag 340 indicate to the external servers 500 that the key 320 is with the lockbox 300. FIGS. 3a-b visually represent the series of actions and related software logic determinations that the illustrative method and system perform to determine that the key 320 has been carried away from the property 50. In the event that the key 320, attached to the asset tag 340, is not returned to the lockbox 300, the software logic will first determine whether the communication between the lockbox 300 and the wireless access device 200 has been terminated. If the wireless access device 200 has become too geographically distant from the lockbox 200, the communication terminates. This first determination may be optional in some examples as, for example and as noted above, the lockbox 300 is not required to be a wireless lockbox in some examples.

The software logic will (also or instead) determine either the showing agent 235 or other authorized access user has crossed 120 the geofence 100. Such determination is made if the wireless access device 200 (the user's mobile device) has crossed 120 the earlier established virtual geographic boundary 100.

Finally, the software logic will determine whether the communication between the mobile device 200 and mobile application 220, and the asset tag 340, is or has continued after the geofence 100 has been crossed 120. If the communication between the mobile application 220 and the asset tag 340 continues to exist, then the software recognizes that the wireless access device 200 and key 320 have maintained spatial proximity outside the geofence 100. Such is the case when a showing agent 235, carrying both the wireless access device 200 (typically their phone) and the key 320 with the attached asset tag 340, moves away from the property 50 and crosses 120 the geofence 100. With the mobile phone or other access device 200 acting as the transceiver, the software concludes that both the wireless access device 200 and the asset tag 340 are traveling away from the listing 50 and the earlier established virtual geographic boundary 100. The software is able to identify who is in possession of the key by identifying the user associated with the wireless access device 200 earlier assigned in current communication with the asset tag 340. At the conclusion of these determinations, the mobile application 220 sends a notice to the application's central servers 400 with this information. Further, the unique identifying information of the asset tag, which was earlier stored by the central server at initialization processes described above, is used during this process to identify the property address at issue.

Once the above software logic determinations are made, the software is configured to instruct the mobile application 220 to trigger a series of communications substantially in real time, highlighted in FIG. 3B. Various parties may receive notifications from the mobile application 220/250 installed on their individual devices 200/255, and/or via other online resources, such as a website, upon this determination.

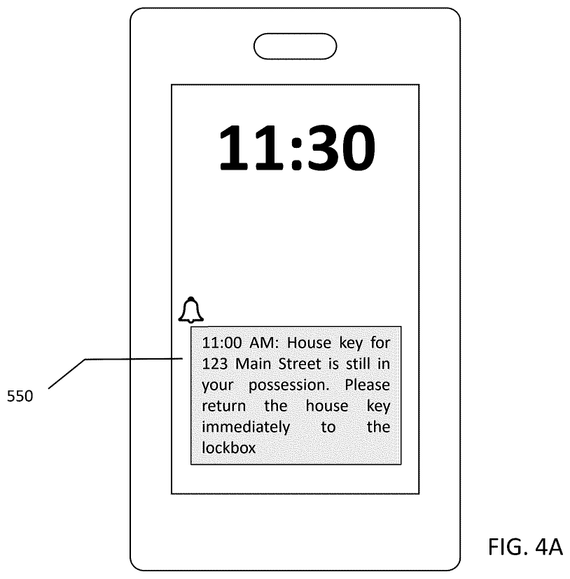

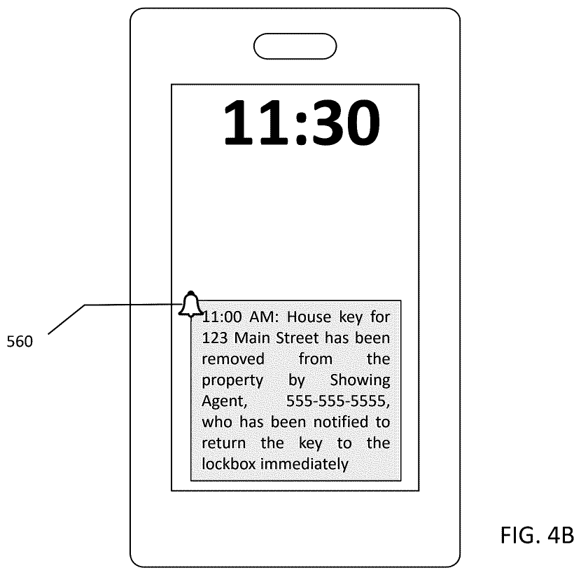

First, the mobile application 220 installed on the showing agent's device 200 notifies 550 the showing agent 235 that they are in possession of the key 320 and prompts them to return it, as shown in FIG. 4A. Secondly, the mobile application installed on other devices 250/255 associated with the property may also notify 560 other agent, and/or other users 245 associated with the property 50 that the showing agent 235 is in possession of the key 320 and has been prompted to return it, as shown in FIG. 4B. For example, notifications may be sent to other showing agents who have upcoming, subsequent appointments 245 that the key 320 is removed from the lockbox 300 and thus the listing 50 is now currently unavailable for showings. The occupant of the property may be warned that the key 320 is missing, posing a possible security risk to the occupant who may wish to return. The listing agent may also be notified so that other actions may be taken, such as calling or otherwise contacting the agent 235 that has the key 320. Any service providers (cleaning or maintenance for example) may be notified as well. The property security system may be notified, as the property may be unsecured as a result of the agent 235 departing, and a security system may be set to armed or to automatically lock the property, if desired.

FIGS. 4A-4B are merely exemplary, and as such, it should be appreciated that changes, including but not limited to its configuration and language, may differ by the property access management tracking system and by whether the notification is presented by a mobile application (as illustrated) or a web browser.

It may be noted that the solution suggested goes beyond typical use of an asset tag. In most cases, the asset tag is used to identify the location of the asset that has been tagged. In the present situation, however, the location is known, because the asset tag is in communication the mobile device 200 and mobile application 220. The step taken however, is that the actual possessor of the key 320, that is user 235, is now known, and that person can be contacted and told to return the key.

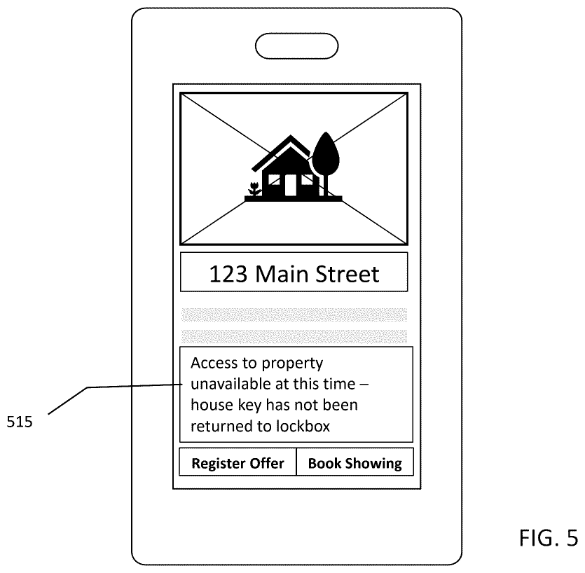

In some examples, as shown in FIG. 5, a warning 515 is issued on the listing page of the property access management tracking system that the key 320 is currently unavailable and the property 50 inaccessible as a result of the key 320 being carried off premises 50. As an example, the commercially-available property access management tracking system includes Supra key management system; however, it is to be understood that any equivalent electrical key and/or property access system may be configured with this logical pathway. FIG. 5 is merely exemplary, and as such, it should be appreciated that changes, including but not limited to its configuration and language, may differ by the property access management tracking system and by whether the notification is presented by a mobile application (as illustrated) or accessed on a web browser.

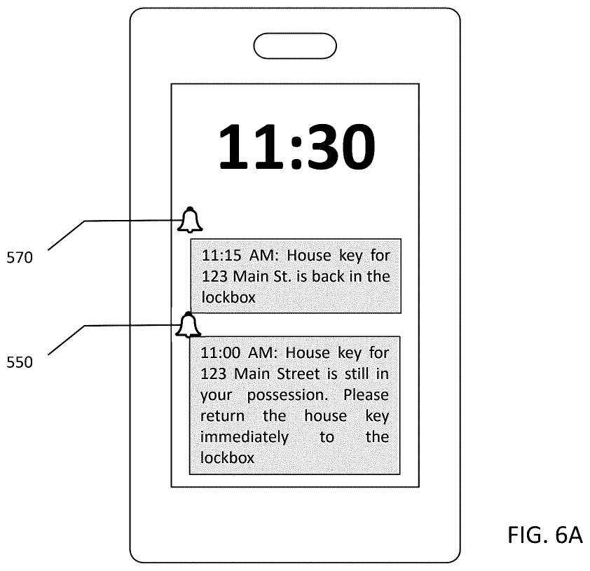

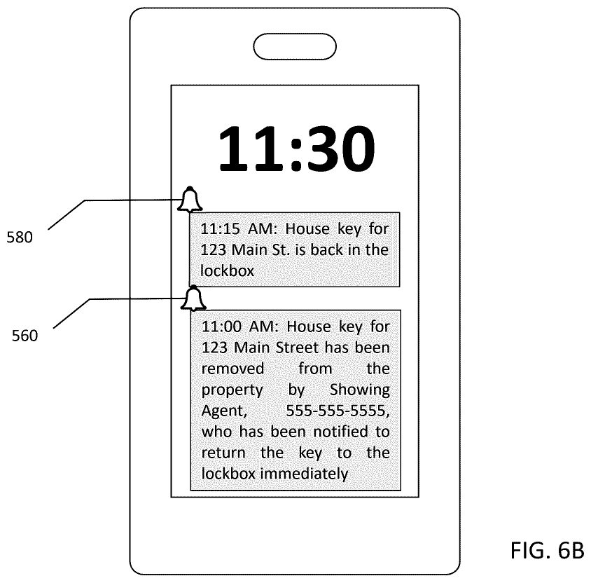

FIG. 6A represents another real-time notification event 570 that occurs when the showing agent has returned to the premises to return the key 320, and the lockbox 300 and the asset tag 345 are once again in communication 170 due to their increasing spatial proximity. The establishment of these communication 170 indicates to the servers 500 that the key 320 has been returned to the lockbox 300. This indication is further confirmed once the showing agent has crossed back over the geofence 100, terminating communications between the asset tag and the showing agent's wireless device, meanwhile the communications between the asset tag 340 and the lockbox 300 have been sustained. As illustrated in FIG. 6B, upon this occurrence, notifications 580 are sent to interested parties 235/245, including those who had previously received notifications when the communication between the lockbox 300 and the asset tag 340 originally terminated, that the key 320 has been returned to the lockbox. Additionally, the missing key warning on the listing page is removed. FIGS. 6A-6B are merely exemplary, and as such, it should be appreciated that changes, including but not limited to its configuration and language, may differ by the property access management tracking system and by whether the notification is presented by a mobile application (as illustrated) or accessed on a web browser.

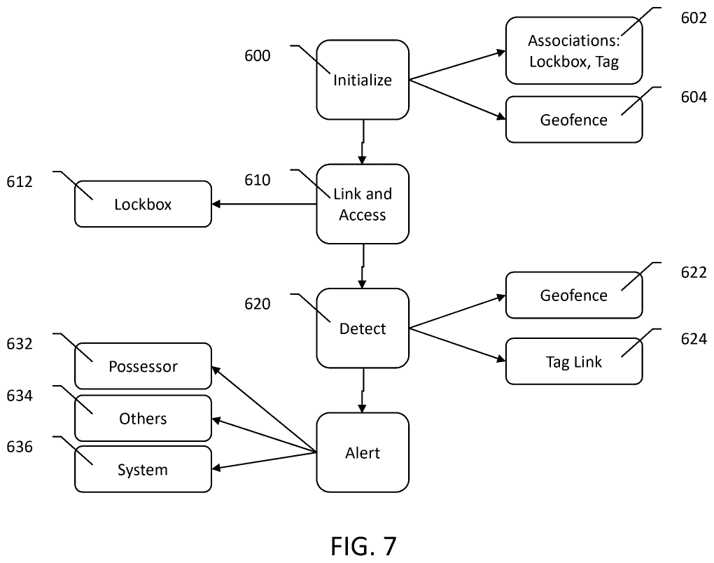

FIG. 7 shows an illustrative method for tracking the location of a key. At block 600, the system is initialized in relation to a property that is to be shown. The property access management software may create two sets of associations at 602. The key for the property is associated with a wireless access tag, and the key is physically attached to the wireless access tag. In addition, the lockbox is associated with the property. Next, the system establishes the geofence as a virtual boundary surrounding the property.

Once the associations are created 602 and the geofence is established 604, the property is ready for showing (or visitation by other authorized users, such as cleaners and maintenance personnel). Upon arrival at the property, an authorized user may link their mobile device to the lockbox to access the key, as indicated at 610. The lockbox 612 responds by opening and thereby providing access to the key. This operation may use, for example, Bluetooth low energy, Bluetooth, and/or near field wireless communications and/or any other suitable wireless communications protocol and technology.

By linking the mobile device to the lockbox, the compartment of lockbox can now be unlocked via the mobile application in response to the presentation of the agent's credentials and the transmission of an electronic unlocking signal. The lockbox 612 may also make note of various data, including timestamping the access by the mobile device and storing identifying information of the asset tag and the authorized user for the mobile device, providing a log of visits to the property.

Alternatively or in addition to the storage of identifying information by the lockbox, the log of visits with the identifying information of the lockbox, asset tag, and authorized user may also be stored by the central servers. If so enabled, the lockbox may store any suitable additional information, or communicate to a building security system to disarm the security system and/or prompt use of security cameras on site to track the authorized user's visit to the property.

When the key is removed from the lockbox, the user's mobile device links to the tag that has been physically attached to the key. In some examples, the mobile device can detect whether the mobile device remains inside the geofence 622, as well as whether the mobile device remains in communicative contact with the tag on the key. If the mobile device is outside the geofence 622, the mobile device next determines whether the link to the tag 624 on the key remains active. If so, the mobile device application determines that the key has left the geofence and the authorized user has failed to correctly return the key at the end of the property visit, and an alert is generated.

In parallel, optionally, the lockbox may attempt to link to the tag after the tag has been removed. If the lockbox can no longer link to the tag, the key system may be notified. This may not generate an alert, in some examples if, for example, the mobile device is able to verify that it remains within the geofence and is still linked to the tag. On the other hand, if the lockbox cannot link to the tag, and the mobile device cannot link to the tag, the key may be lost, and a lost key alert may be generated. The mobile device may be queried to determine where and when the tag on the key was last linked thereto, to aid in finding the key. If the lockbox cannot link to the tag, and the mobile device is outside the geofence and is still linked to the tag, an alert 630 may be generated that the user has failed to correctly return the key. Alerts 630 can take several forms. The possessor 632 of the mobile device that last accessed the property (known when the lockbox releases the key due to linking with the mobile device as described above) can be alerted. The possessor of the key, who will also be known due to the linking of the key tag to their mobile device or by their unique identifier as recorded in the visit log, may also be alerted. Others, such as other scheduled showing agents, may be alerted, as well as the owner of the home and/or the listing agent, for example, as indicated at 634. A property security system may also be alerted 636 to this event. Additionally, the receipt of this information can further trigger other actions and/or series of logic determinations previously set for the lockbox. For example, the system could be set to automatically lock the listing if it detects that the key has left the premises.

Further applications of this method and system may arise. For example, with rental vehicles, a rental key can be equipped with an asset tag, and when the lessee of the vehicle obtains the vehicle, pairing with a rental company application operating on the lessee's smartphone can be performed. This may be part of an automatic vehicle pick-up procedure. Upon return of the vehicle, the lessee is supposed to leave the key in the vehicle. Because such returns often occur at travel facilities, such as the airport, time is of the essence. When the vehicle at the return facility, this can be readily determined, such as using a license plate reader at an entrance to a rental return facility, or using GPS installed in the vehicle, or by pairing of a wireless communication system of the vehicle with a rental return facility system (WiFi, Bluetooth, etc.). For example, many modern vehicles have at least one, if not all, of GPS, WiFi and/or Bluetooth systems installed. In an illustrative method, once the vehicle is determined to be in the rental return facility, if the key leaves the vehicle but remains in contact with the lessee's smartphone, this may trigger an automatic notification to the lessee that the key remains in the lessee's possession and should be returned to avoid a lost key charge, for example. The vehicle can determine such departure quite readily, as the vehicle generally detects key FOB proximity; when the vehicle enters the facility, software in the vehicle may be alerted to the special status of “returning vehicle,” for example. If the key leaves proximity of the vehicle before being checked in by a leasing agent, an alert can be generated. Here the alert would go from the vehicle to a rental agency server, and then to the user's mobile device. The mobile device may even prevent false alerts by confirming absence of the key FOB in proximity thereto. By automating this process, the lessee can be notified much quicker than if the rental facility waits for a rental agent to check the car back into the facility. This saves time for the lessee who may, for example, be trying to catch a flight, while providing added security and preventing loss.

A method may similarly be used with vacation rental properties. In a short-term vacation rental, the lessee often checks out of the property using an application, which will remind the user to lock doors and leave the key (among other things). If the user still has the key after the checkout process is performed with the application, the application can automatically determine this, again using, if desired, a geofence surrounding the vacation rental property. The system may also communicate to a lockbox, in order to check whether the key has been returned, prior to querying the application on the user's mobile device. Once again, notification can occur much sooner than would otherwise take place if, for example, the key is not identified as missing until a subsequent tenant arrives, the owner, or a cleaning person arrives at the property.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “a” or “an” are used, as is common in patent documents, to include one or more than one, independent of any other instances or usages of “at least one” or “one or more.” Moreover, in the claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic or optical disks, magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description.

The Abstract is provided to comply with 37 C.F.R. § 1.72(b), to allow the reader to quickly ascertain the nature of the technical disclosure. It is submitted with the understanding that it will not be used to interpret or limit the scope or meaning of the claims.

Also, in the above Detailed Description, various features may be grouped together to streamline the disclosure. This should not be interpreted as intending that an unclaimed disclosed feature is essential to any claim. Rather, innovative subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the protection should be determined with reference to the appended claims, along with the full scope of equivalents to which such claims are entitled.

What is claimed is:

1. A method for tracking a key for a property, the key stored in a lockbox, the method performed by use of a property access management tracking software, the method comprising:
assigning a property address to the lockbox and to a wireless asset tag physically attached to the key for the property;
establishing an electronic geofence surrounding the property;
a) establishing wireless communication between the wireless asset tag and a wireless access device, the wireless access device being possessed by a user visiting the property;
b) determining, after step a), that the wireless access device has crossed outside the geofence surrounding the property address; and
c) determining, responsive to step b), that communication between the wireless access device and the wireless asset tag has continued after step b); and
in response to the determinations b) and c), generating at least one notification indicating that the key is outside the geofence.

2. The method of claim 1, further comprising transmitting the determinations b) and c) and at least one notification to a central authority for distribution over a wireless network service.

3. The method of claim 1, wherein the at least one notification indicates that the user of the wireless access device has possession of the key.

4. The method of claim 3, wherein the at least one notification instructs the user of the wireless device to return the key to the lockbox.

5. The method of claim 2, wherein the at least one notification is directed to other agents associated with the property.

6. The method of claim 5, wherein the property is a real estate listing having a showing schedule associated therewith, and the at least one notification is sent to an agent on the showing schedule to indicate the key is unavailable.

7. The method of claim 1, further comprising establishing wireless communication between the wireless asset tag and the lockbox at the property.

8. The method of claim 7, wherein determination b) is made when communication between the wireless asset tag and the lockbox has terminated due to increasing geographic distance.

9. The method of claim 1, further comprising establishing wireless communication between the wireless access device and the lockbox at the property, and in response thereto, providing access to the key at the lockbox to a possessor of the wireless access device.

10. The method of claim 9, further comprising recording, at the lockbox, an identifier of the wireless access device used to establish wireless communication with the lockbox to access the key, and using the identifier of the wireless access device to direct at least one notification indicating that the key is outside the geofence.

11. The method of claim 1, wherein the property is a real estate listing, and wherein the at least one notification includes a transmission to a central server and the method further comprises the central server generating a warning on a listing page for the property that the key is currently unavailable.

12. The method of claim 1, wherein the geofence encompasses an area around the property address, forming a virtual boundary.

13. The method of claim 12, wherein the property access management software utilizes a wireless data service network, Wi-Fi, a global positioning system, a radio frequency identification, or a mobile phone's location services to define the virtual boundary of the geofence.

14. A method for tracking a key stored within a lockbox for a property, the method comprising:
initializing the property access management software by:
assigning a property address to the lockbox;
physically attaching a wireless asset tag to the key, and associating the wireless asset tag to the property address; and
establishing an electronic geofence surrounding the property
linking a mobile device of an authorized user to the lockbox via a wireless communication, wherein the linking establishes authority for the user to access the key stored within the lockbox;
the lockbox allowing the user to obtain the key and physically attached wireless access tag therefrom;
a) detecting that the wireless access device has crossed outside the geofence;
b) detecting that the association between the wireless access device and the wireless asset tag has continued after step a); and
in response to a) and b), generating at least one notification indicating that the key is outside the geofence.

15. The method of claim 14, wherein generating at least one notification includes issuing an alert, using the mobile device, to the authorized user that the key has passed beyond the geofence without being returned to the lockbox.

16. The method of claim 14, further comprising detecting that the wireless asset tag has returned to the lockbox and generating a notification that the key has been returned.

17. The method of claim 14, wherein linking the wireless access device to the lockbox further comprises storing user credentials on the wireless access device, and storing identifying information for the mobile device on the lockbox when the wireless access device is linked to the lockbox.

18. The method of claim 14, wherein accessing the key from the lockbox using the wireless access device further comprises:
authenticating user credentials by the lockbox; and
unlocking the lockbox upon successful authentication of user credentials.

19. A system for tracking a key for a property, the key stored in a lockbox, the system comprising:
a lockbox assigned to a property address;
a wireless asset tag physically attached to the key for the property;
a mobile device possessed by a user visiting the property and having thereon a mobile application;
a central server adapted for communication with at least the mobile device which is operating the mobile application, wherein:
the central server stores data associating the property address with the lockbox, the wireless asset tag, and an electronic geofence surrounding the property;
wherein the mobile application is configured to use the mobile device to communicatively link to the lockbox to allow the user to access the key stored therein;
wherein the mobile application is configured to use the mobile device to communicatively link to the wireless asset tag attached to the key and to then:
a) determine that the wireless access device has crossed outside the geofence surrounding the property address;
b) determine, responsive to a), that communication between the wireless access device and the wireless asset tag has continued after a); and
in response to a) and b) generate at least one notification indicating that the key is outside the geofence.

20. The system of claim 19, wherein the mobile application is configured to generate the at least one notification by issuing an alert to the user carrying the mobile device.
